(19) United States
(12) Patent Application Publication
(10) Pub. No.: US 2008/0146701 A1
(43) Pub. Date: Jun. 19, 2008

(54) Manufacturing process of cellulose nanofibers from renewable feed stocks

(76) Inventors: Mohini M. Sain, Toronto (CA); Arpana Bhatnagar, North York (CA)

Correspondence Address: MOHINI M. SAIN;FACAULTY OF FORESTRY, 33 WILLCOCKS STREET, TORONTO, ON, M5S 3B3, omitted

(21) Appl. No.: 10/936,236

(22) Filed: Sep. 9, 2004

Related U.S. Application Data
(60) Provisional application No. 60/512,912, filed on Oct. 22, 2003.

(51) Int. Cl. C08L 1/02; B32B 1/00; B29C 39/02; B29C 47/00

(52) U.S. Cl. 524/9; 428/220; 264/299; 162/54; 264/176.1

(57) ABSTRACT

Cellulose nanofibers have been processed from renewable feedstock in particularly from natural fibers, root crops and agro fibers, wherein the pulp was hydrolysed at a moderate temperature of 50 to 90 degree C., one extraction was performed using dilute acid and one extraction using alkali of concentration less than 10%; and residue was cryocrushed using liquid nitrogen, followed by individualization of the cellulose nanofibers using mechanical shear force. The nanofibers manufactured with this technique have diameters in the range of 20-60 nm and much higher aspect ratios than long fibers. Due to its lightweight and high strength its potential applications will be in aerospace industry and due to their biodegradable potential with tremendous stiffness and strength, they find application in the medical field such as blood bags, cardiac devices, valves as a reinforcing biomaterial.

### BACKGROUND OF THE INVENTION

US PATENT DOCUMENTS

| | | | |
|---|---|---|---|
| 4,842,924 | Jun. 27, 1989 | Farris; Richard J. Cohen, Yachin DeTeresa, | 428/221 |
| | | Steven J. | |
| 6,103,790 | Aug. 15, 2000 | Cavaille; Jean-Yves, Chanzy; Henri, Favier; | 524/13 |
| | | Veronique, Ernst; Benoit | |
| 6,432,532 | Aug. 13, 2002 | Perez; Mario A., Swan; Michael D. Louks; | 428/359 |
| | | John W. | |
| 6,231,657 | May 15, 2001 | Cantiani; Robert, Guerin; Gilles, Senechal; | 106/162.8 |
| | | Alain, Vincent; Isabelle, Benchimol; Joel | |
| 6,312,669 | Nov. 6, 2001 | Cantiani; Robert, Willemin; Claudie, | 424/49 |
| 6426,189 | Jul. 30, 2002 | Helbert; William, Chanzy; Henri | 435/6 |
| | | Dominique, Ernst; Steffen, Schulein; | |
| | | Martin, Husum; Tommy Lykke, Kongsbak; | |
| | | Lars | |
| 6,117,545 | Sep. 12, 2000 | Cavaille; Jean-Yves, Chanzy; Henri, | 428/357 |
| | | Fleury; Etienne, Sassi; Jean-Fran.cedilla.ois | |
| 6,485,767 | Nov. 26, 2002 | Cantiani; Robert, Knipper; Magali, Vaslin; | 426/96 |
| | | Sophie | |
| 5,964,983 | Oct. 12, 1999 | Dinand; Elisabeth, Chanzy; Henri, Vignon; | 162/27 |
| | | Michel R., Maureaux; Alain, Vincent; Isabelle | |

Composites, consisting of a polymeric matrix and a synthetic filler (e.g., glass fiber, carbon, or aramid) as reinforcement have been widely used in many applications (automotive, packaging, construction, etc.) because of their high performance and great versatility. However, current environmental problems caused by these products at end of life disposal, their partial combustibility, and the increasing demand for techniques for the recycling of these materials have resulted in the replacement of synthetic fillers by natural organic ones such as natural fibers, wood fibers, starch, etc. These kinds of fibers, compared to inorganic fillers, have many advantages, including low cost, lower density, no abrasion of the processing equipment, similar moduli, good thermal properties, and biodegradability. The natural fibers used in most of the application like paper making, textile etc. are bundles of individual fibers held together by thin layers of polysaccharides, pectins and lignin. Cellulose microfibrils from various sources have been utilized already in dry form as food formulations as mentioned in U.S. Pat. No. 6,485,767. Tunicin microfibrils have been used as the reinforcement with polymer matrix in paints and nanocomposites, as per U.S. Pat. No. 6,103,790. Surface-modified cellulose microfibrils were used as filler in composite materials (U.S. Pat. No. 6,117,545) and this composite material may be shaped to provide films, moldings, fibers or yarns.

This present invention relates to the potential of extracting natural nanofibers from plant fibers, root crops fibers, wood fibers and agro based fibers using innovative chemo-mechanical methods and then making nanocomposites using biopolymer or non-biopolymer thermoplastic matrix. The advantages of these natural nano-fibers as reinforcing material will be their high mechanical properties, low density and biodegradability. Other advantages will be in terms of alternate use of the agricultural land, less dependency on fossil reserves and renewable raw material. Generally, cellulose is present in the form of a hierarchy of structures. The cellulose molecules are always biosynthesized in the form of nano-sized microfibrils (referred as nanofibers in the present inventions), which are in turn assembled into fibers, films, walls, etc. The cellulose nanofibers can be considered to be an important structural element of natural cellulose. It consists of an assembly of cellulose chains whose average degree of polymerization is greater than 1,000 and whose degree of perfection in their parallel organization is expressed in its crystallinity percentage.

The structure of natural fibers is comprised of different hierarchical microstructures. The single fibre or elongated cell has diameter around 20-30 μm. Each fibre cell wall is consisted of primary cell wall and three secondary cell walls. The lumen in the centre is responsible for water uptake. Each cell wall is consisted of cellulose microfibrillar phase and a matrix phase comprising of hemicellulose, pectin and lignin. Primary plant cell wall is composed of cellulose nano-sized microfibrils (9-25%) and an interpenetrating matrix of hemicelluloses (25-50%), pectins (10-35%. Approximately 90% of the cell wall consists of carbohydrates (mostly pentose and hexose units). The cellulose forms the framework of the cell wall while hemicelluloses cross-link non-cellulosic and cellulosic polymers. Pectins provide cross-links and structural support to the cell wall. Cellulose nanofibers arrangement in the primary wall is random.

Secondary walls are derived from primary walls by thickening and inclusion of lignin into the cell wall matrix and occur inside the primary wall. Secondary cell walls of plants contain cellulose (40-80%), hemicelluloses (10-40%) and lignin (5-25%). The arrangement of these components allows cellulose nano-sized microfibrils to be embedded in lignin. Cellulose and hemicelluloses appear to be more structurally organized in the secondary cell wall than in the primary cell wall.

U.S. Pat. No. 6,511,746 issued to Collier, et al. discloses the manufacture of microfibrils from dissolved cellulose for threads, yarns and fabric making.

Imposing orientation in the incipient microfibrils prior to or during crystallization of the cellulose produces continuous fibers of substantial aspect ratio, without significant entanglement.

U.S. Pat. No. 6,485,767 issued to Cantiani, et al. discloses the use of cellulose microfibrils with a crystallinity index not more than 50%, with at least a polyhydroxylated compound in dry form as additive for food formulations, the content of this combination being more than 0% and less than 20% by weight relative to the total weight of the food formulation.

U.S. Pat. No. 6,117,545 issued to Cavaille, et al. discloses the method of making surface modified cellulose microfibrils and proposes the use as filler in composite materials. At least 25% by number of the hydroxyl functions on the surface of the microfibrils are etherified by at least one organic compound including at least one function capable of reacting with the hydroxyl groups of the cellulose.

U.S. Pat. No. 6,103,790 issued to Cavaille, et al. discloses the making of cellulose reinforced polymers and their applications with tunicin microfibrils. Said polymers have a wide variety of uses, particularly in paints and nanocomposites.

U.S. Pat. No. 5,964,983 issued to Dinand, et al. discloses the method for preparing a microfibrillated cellulose from primary cell wall of sugar beet pulp.

Until now, all known celluloses have had disadvantages.

Bacterial celluloses microfibrils are very expensive and can cause contamination problem in alimentary applications.

Cellulose microfibrils from primary cell walls as described in almost all the previous arts cited can be obtained only from the sources which are principally constituted of parenchyma cells; therefore the raw material choice is very limited.

Surface modified cellulose microfibrils as described in previous arts are actually cellulose derivative, and not pure cellulose, therefore in high end application such as medical application, this may be a problem.

This invention relates to providing high strength light weight cellulose nanofibers from natural sources for use as reinforcement in polymer matrix.

### BRIEF SUMMARY OF THE INVENTION

The present invention relates to a process for extracting nanofibers from natural sources like hemp, flax, jute; root crops like rutabaga, swede root, turnip and agro based fibers like wheat straw, baggasse and corn cops and wood fibers. Since nanofibers obtained with this technique have diameters in the range of 5-50 nm and very high aspect ratios than long fibers, they have high reinforcing potential and can be utilized in polymer matrix as a filler in producing materials of very high strength at low cost and weight in an environmentally friendly manner.

### BRIEF DESCRIPTION OF THE DRAWINGS

FIG. 1 SEM of fibers chemically treated with acid followed by alkali; A) flax, B) hemp

FIG. 2 Transmission electron micrographs of cellulose nanofibers after chemo-mechanical treatment A) flax, B) hemp, C) rutabaga, D) wheat

FIG. 3 Atomic force micrographs of cellulose nanofibers A) hemp, B) flax, C) bleached Kraft pulp D) rutabaga

FIG. 4 Flax bast nanofibers after gradual increase in number of passes during defibrillation process showing better separation of nanofibers

FIG. 5 Wheat straw nanofibers after gradual increase in number of passes during defibrillation process showing better separation of nanofibers

FIG. 6 Hemp nanofibers after gradual increase in number of passes during defibrillation process showing better separation of nanofibers

FIG. 7 Rutabaga nanofibers after gradual increase in number of passes during defibrillation process showing better separation of nanofibers

FIG. 8 Size distributions for flax bast nanofibers showing the maximum nanofibers within the diameter range of 10 to 60 nm

FIG. 9 Effect of chemo-mechanical treatments on hemp fibre reinforced composites' mechanical performance A) Tensile strength, B) Young's modulus

FIG. 10 Effect of chemo-mechanical treatments on flax bast fibre reinforced composites' mechanical performance A) Tensile strength, B) Young's modulus

FIG. 11 Effect of chemo-mechanical treatments on rutabaga fibre reinforced composites' mechanical performance A) Tensile strength, B) Young's modulus

FIG. 12 Mechanical performance comparisons of nanocomposites from different sources A) Tensile strength, B) Young's modulus

### DETAILED DESCRIPTION OF THE INVENTION

Natural sources such as wood pulp, hemp, flax, wheat straws were extracted and a composite film was prepared by using cellulose nanofibers thus as reinforcement in polymer matrix. In this invention, nanofibers have been derived from secondary cell walls; therefore higher yield is achieved as compared to the nanofibers obtained only from primary cell walls rich sources. The diameter obtained of these nanofibers was found to be 5-50 nm and length in few tens nanometres.

Cellulose nanofibers can be extracted from the cell walls by two isolation processes: mechanical or chemo-mechanical. Purely mechanical process can produce refined and finer fibrils of several micrometers long and between 50 to 1000 nm in diameter.

However in the present invention, a combined chemical and mechanical process is used to obtain even finer fibrils, between 5 and 50 nm diameter range.

In the present invention the crude cellulose was obtained using chemical treatments like extraction of hemicellulose, lignin and pectin and then to obtain nanofibers from it by very high pressure mechanical shearing using innovative cell puncture technique.

The cellulose nanofibers can be obtained from many sources, for example plant fibers, agro based fibers, wood fibers, root crops fibers etc.

For example; plant fibers sources of nanofibers can be from hemp, flax, jute, kenaf, sisal or the like.

Agro based sources of nanofibers may be from baggasse, corn cops, wheat straw or the like.

The root crop sources of nanofibers may be from rutabaga, turnip, or the like.

The present invention is illustrated with reference to flax bast, hemp bast, rutabaga, wheat straws and wood fibers.

Cellulose fibrils are usually strongly self-associated in the walls or the fibers. Secondary walls, which are mainly found in wood, are distinct from primary walls, a typical example of which is parenchyma. Examples of parenchyma consist of sugarbeet pulp, citrus fruits and most fruit and vegetables.

In the secondary walls, the nanofibers are organized in the form of highly oriented sheets thus forming an in-dissociable fibre. They are conventionally in the form of aggregates from a few tens of nanometres to a few micrometers. These aggregates consist of elementary microfibrils which cannot be disentangled, during their homogenization, without resulting in breaking them.

In the context of the present invention, the cellulose fibrils considered are cellulose nanofibers, obtained from cells with primary and secondary cell walls. It is possible to disentangle these cellulose nanofibers from cell walls during homogenization steps.

This property is connected with conditions of form: their diameter and their length which is assessed rather in its ratio to the diameter via an aspect ratio. This property is very greatly dependent on the individuality of the nanofibers). This property of reinforcement is also connected, although to a lesser degree, with their rigidity, which is itself strictly connected with their Crystallinity, whose value increases as their surface area/volume ratio decreases. This Crystallinity is estimated in a well-known way by examination of the X-ray diffraction diagrams. The important corollary of the dependence of the reinforcement properties of the nanofibers is that it is considerably altered by their aggregation. The nanofibers which can be used for the invention are distinguished in this from what are ordinarily called microcrystalline celluloses, which result from hydrolysis of wood or cotton cellulose, particularly of its hydrochloric hydrolysis, of which the degree of polymerization is already clearly lower, and which above all are not individualized; microcrystalline celluloses which, when they undergo a suitable treatment for individualizing their elements, only provide microcrystal which, even if they more or less still have the diameter of the starting cellulose, are much shorter, for example, approximately 100 nm for wood cellulose.

For proper execution of the invention, it is desirable for the characteristics of the nanofibers revealed above to be exactly produced. The nanofibers which can be used for the invention generally consist of a series of microcrystal separated by zones of amorphous cellulose, the flexibility that they have coming, on one hand, from the length of the microcrystal, and on the other hand, from the presence of the amorphous intermediate segments. This definition which has been given for the nanofibers according to the invention also includes the very long cellulose monocrystals which are obtained with an aspect ratio greater than 60 by acid hydrolysis of natural cellulose fibers. There are possibilities for balancing these characteristics; thus, long nanofibers with a certain flexibility may still be acceptable for the invention, as long as this does not hinder their individuality, or else nanofibers with a small diameter, which, at comparable weight content with respect to that of nanofibers with a larger diameter, compensate for their lack of rigidity by a larger density in number and the formation of a denser network.

The phenomenon of reinforcement comes from the fact that the microfibrils are dispersed in the polymer matrix, within which it organizes itself into a sort of lattice whose unit cell depends on their weight or volume fraction and on their dimensional characteristics

The preparation process comprises the following steps:

(a) first acidic or basic extraction, after which a first solid residue is recovered,

(b) optionally, second extraction, carried out under alkaline conditions, of the first solid residue, after which a second solid residue is recovered,

(c) washing of the first or second solid residue,

(d) dilution of the third solid residue obtained after step (c) so as to obtain a solids content of between 2 and 10% by weight,

(e) homogenization of the dilute suspension.

In step (a), the term “pulp” is intended to refer to wet, dehydrated pulp stored by ensilage or partially depectinized.

The extraction step (a) can be carried out in acidic medium or in basic medium.

For an acidic extraction, the pulp is suspended in an aqueous solution for a few minutes so as to homogenize the acidified suspension at a pH of between 1 and 3, preferably between 1.5 and 2.5.

This operation is carried out with a 1 M acid solution such as hydrochloric acid or sulphuric acid.

This step may be advantageous for removing the calcium oxalate crystals which may be present in the pulp, and which, on account of their highly abrasive nature, can cause difficulties in the homogenization step.

For a basic extraction, the pulp is added to an alkaline solution of a base, for example sodium hydroxide or potassium hydroxide, with a concentration of less than 9% by weight, more particularly less than 6% by weight. Preferably, the concentration of the base is between 1 and 2% by weight.

A small amount of a water-soluble antioxidant, such as sodium sulphite Na₂SO₃, may be added in order to limit the oxidation reactions of the cellulose.

Step (a) is generally carried out at a temperature of between about 60.degree C. and 100 degree C., preferably between about 70 degree C. and 95 degree C.

The duration of step (a) is between about 1 hour and about 4 hours.

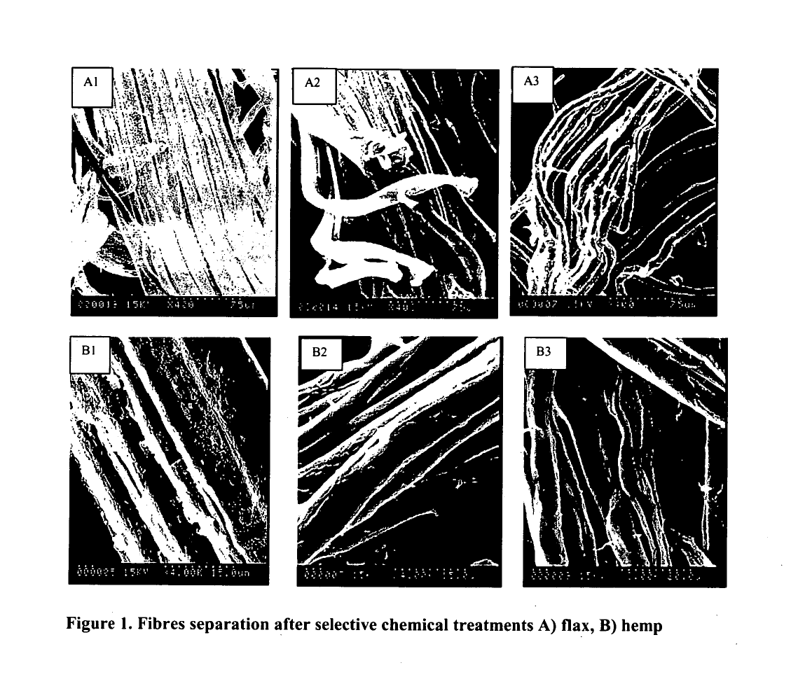

During step (a), partial hydrolysis takes place with release and solubilization of most of the pectins and hemicelluloses, while at the same time retaining the molecular mass of the cellulose. FIG. 1 demonstrates the separation of fibers due to the removal of pectins and hemicelluloses.

The solid residue is recovered from the suspension obtained from step (a) by carrying out known methods. Thus, it is possible to separate the solid residue by centrifugation, by filtration under vacuum or under pressure, with filter gauzes or filter presses, for example, or else by evaporation.

The first solid residue obtained is optionally subjected to a second extraction step carried out under alkaline conditions.

A second extraction step is carried out when the first step has been carried out under acidic conditions. If the first extraction has been carried out under alkaline conditions, the second step is only optional.

According to the process, this second extraction is carried out with a base preferably chosen from sodium hydroxide and potassium hydroxide, whose concentration is less than about 9% by weight, preferably between about 1% and about 6% by weight.

The duration of the alkaline extraction step is between about 1 and about 4 hours. It is preferably equal to about 2 hours.

After this second extraction, if it is carried out, a second solid residue is recovered.

In step (c), the residue derived from step (a) or (b) is washed thoroughly with water in order to recover the residue of cellulosic material.

The cellulosic material from step (c) is then optionally bleached, in step (d), according to the standard methods. For example, a treatment with sodium chlorite, with sodium hypochlorite or with hydrogen peroxide in a proportion of 5-20% relative to the amount of solids treated can be carried out.

Different concentrations of bleaching agent can be used, at temperatures of between about 18 degree C. and 80 degree C., preferably between about 50 degree C. and 70 degree C.

The duration of this step (d) is between about 1 hour and about 4 hours, preferably between about 1 and about 2 hours.

A cellulosic material containing between 90 and 95% by weight of cellulose is thus obtained.

It may be preferable to wash the cellulose thoroughly with water.

The chemically treated residue was freeze-dried and then frozen pulp was crushed with liquid nitrogen. The objective of the cryocrushing is to form ice crystals within the cells. When high mechanical impact is applied on the frozen pulp, ice crystals exert pressure on the cell wall; the cell wall ruptures and liberates the nanofibers. Then the pulp is washed abundantly with distilled water. The resulting suspension, which has optionally been bleached, is then re-diluted in water to a proportion of 2 to 10% solids, before undergoing a homogenization step.

The homogenization step corresponds to a mixing or blending operation or any operation of high mechanical shear, followed by passage of the cell suspension through an orifice of small diameter, subjecting the suspension to a pressure drop of at least 20 MPa and to a high-speed shear action, followed by a high-speed deceleration impact.

The high pressure defibrillation was done with PANDA 2K by NIRO SOAVI S.p.A®. The passage of the suspension through this minute flow passages in the valve under high pressure and controlled flow action subjects the fluid to a condition of high turbulence and shear that creates the efficient mechanism of reduction in size [to submicron level]. The sample was repeatedly exposed to chemical treatment, freezing followed by this defibrillation at 0-100 MPa. The temperature of the defibrillation operation is maintained between 80 and 120.degree C., preferably above 100.degree C.

The suspension in the homogenizer is subjected to pressures of between 20 and 100 MPa Homogenization of the cellulosic suspension is obtained by a number of passages which can range between 5 and 30, preferably between 15 and 30, until a stable suspension is obtained.

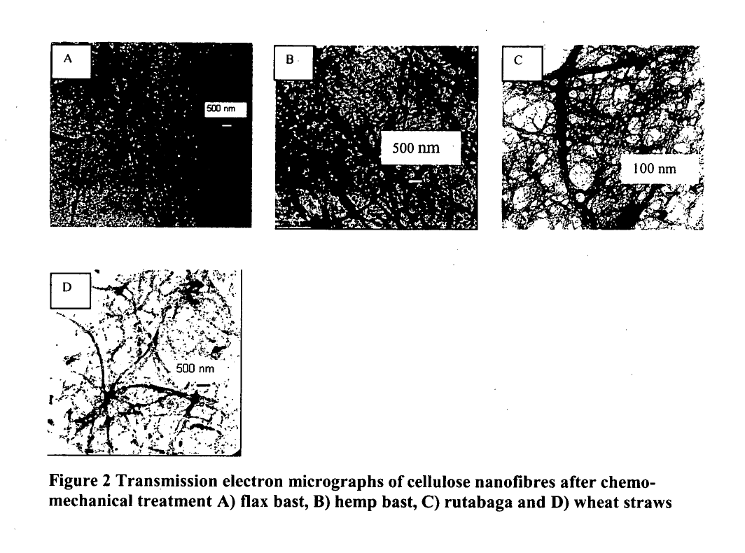

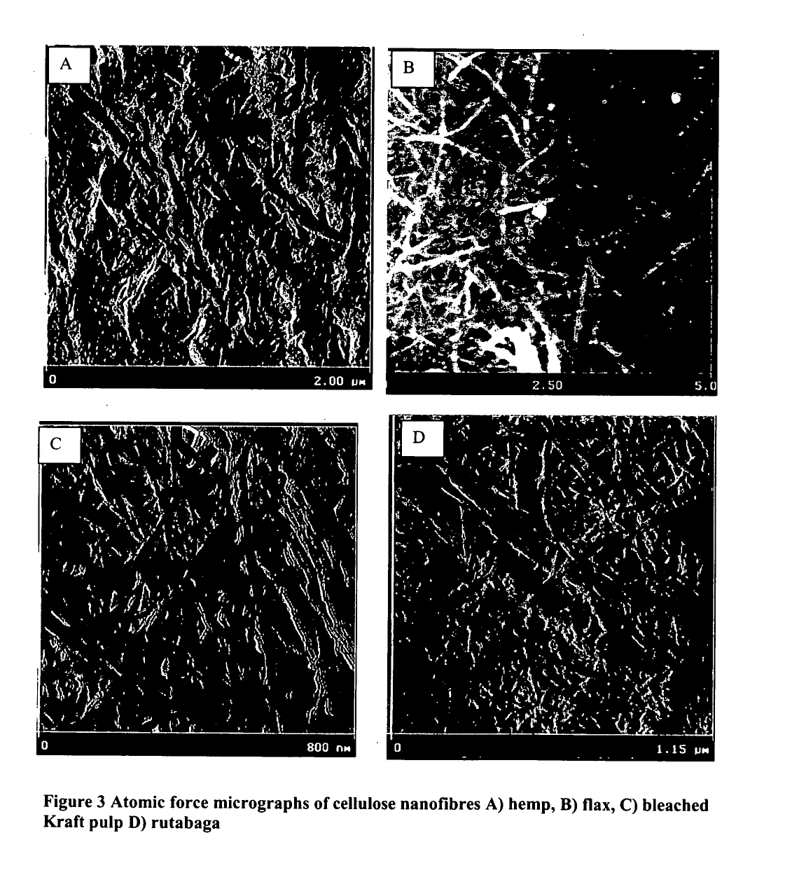

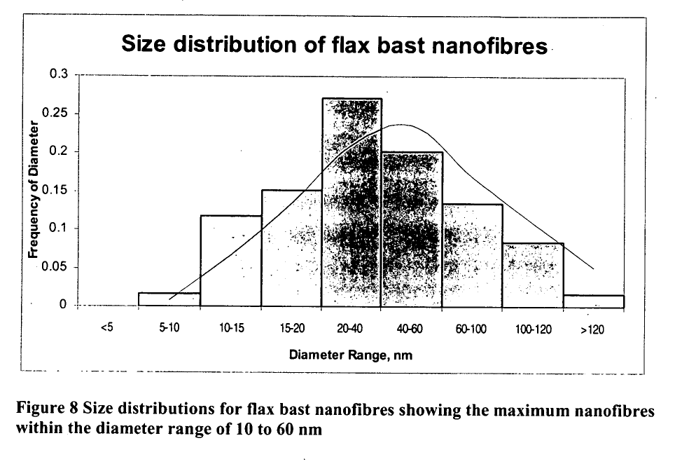

In the application of the invention, the corresponding compositions contain less than 15% cellulose nanofibers in the sense of invention, preferably less than 10%. FIG. 2 and 3 illustrate the isolated nanofibers from various sources. The diameters obtained are in the range of 10-60 nm (FIG. 8).

Cellulose fibrils have a high density of —OH groups on the surface, which try to bond with adjacent —OH group by weak hydrogen bonding. This results in agglomeration or entanglement of the nanofibers; therefore the nanofibers obtained after chemo-mechanical treatments were treated with silane. Silane addition in very low proportion improves the adhesion between the filler and the polymer.

3-Aminoethylaminopropyltrimethoxy silane was introduced in the nanofibers water suspension for improved chemical bonding between resins and nanofibers. A 0.5 wt % solution of silane was used for better dispersion of the nanofibers filler in the PVA polymer. It is expected that silane treatment leads to surface modification of the cellulose nanofibers and hence reducing the entanglements of the nanofibers by reducing the —H bonds. Other silane such as tricholroperflouro octyl silane, alkoxysilane such as vinyltriethoxysilane, vinyltrimethoxysilane etc., can also be used. Other conventional compatibilisers such as maleated polypropylene (MAPP), maleated polyethylene (MAPE), a maleated polylactide, a maleated polyhydroxybutyrate etc. can also be used in small proportions.

A nanocomposite film was prepared using 10% nanofibers and 90% PVA polymer matrix. A thin film was formed by evaporation, by adding polymer matrix. The polymer-nanofibers film is dried in an oven, preferably at a temperature of 40-50 degree C. The evaporation must occur very slowly in order to prevent untimely drying on the surface. The objective of making composite is to demonstrate the effect of using chemo-mechanically treated cellulose nanofibers as filler, on the mechanical performance of the composite films. Composite films were prepared using only 10% of the nanofibers in polyvinyl alcohol matrix. Composite were also prepared using the fibers from each stage of chemical purification and tested for mechanical performance.

### EXAMPLES

The following examples will make the invention more clear.

### Example 1

Preparation of Nanofibers from Flax Fibers.

After having soaked the flax long fibers overnight in alkali of 17.5% w/w concentration, the fibers were washed thoroughly with distilled water. They are then treated with dilute acid preferably HCl between 1-3 hours at 80-90 degree C. The fibers were then washed again and treated with alkali of 2% w/w concentration for 2 hours between 80 and 100 degree C. with constant mechanical stirring. Fibers were washed again and cryocrushed with liquid nitrogen to break the cell wall in fragments to get the nanofibers out of the cell wall by applying high impact.

The sample was then disintegrated for 10 minutes at 2000-RPM speed at 2% consistency. The suspension was then subjected to high-pressure shear in homogenizer to obtain nanofibers. The pressure was maintained between 20 and 100 MPa, preferably between 30 and 70 MPa. The suspension was passed between 5 and 30 passes, preferably between 15 and 25 passes. This suspension is homogenous, nonflocculent and stable for several weeks.

Chemical analysis showed more than 90% cellulose. X-Ray diffractrometry estimated the crystallinity of approx. 58-60%.

The same process was repeated for hemp fibers and wheat straws.

For rutabaga fibers, the pulp was obtained by blending the sample in Warring blender (water to pulp ratio 10:1) for 30 minutes. The other acid and alkali treatments were done in the same manner, as was done for flax fibers.

For wood fibers, bleached kraft pulp was used as starting material. The pulp was cryocrushed and then subjected to high-pressure shear in homogenizer to obtain nanofibers.

### Example 2

Defibrillation Without Chemical Treatments

Natural fibers have length in the range of 5-25 mm and they exist in the form of fiber bundles. Fibers are tightly attached to each other with pectin, which act as cement to bind them together as a bundle of fibers. Without removing the pectic substances it is very difficult to individualise fibers for defibrillation. Moreover the opening of the nozzle in the defibrillator equipment is approximately 1-2 mm and when we pass the suspension of fibers of length 2-25 mm, it chokes the nozzle opening and no circulation is possible for defibrillation.

### Example 3

Defibrillation with Chemical Treatments and Without High Pressure Defibrillation

In one experiment, chemical treatment of the fibers was done but high pressure was not applied for the defibrillation of the fibrils. Then the samples were analyzed using optical microscopy. FIG. 13 shows the fibrils after defibrillation without high pressure and it is clear that still the fibrils are attached to each other and are in the form of bundles. Therefore it is essential to apply a high pressure to isolate theses nanofibers from each other.

### Example 4

Impact of Various Chemical Treatments

Various chemical treatments are done to minimise the content of such as hemicelluloses, lignin, pectins and minerals in the pulp used for isolation of nanofibers. Table I and Table II show the decline in hemicelluloses and lignin content and constant increase of α cellulose in flax and hemp respectively. Higher content of cellulose will lead to a better stiffness and strength of the fibrils.

TABLE I
Chemical analysis of flax bast fibers after selective chemical treatments

| | % α | | % Total | % Other |
|---|---|---|---|---|
| | Cellulose | % Hemicellulose | Lignin | compounds |
| Untreated fibers | 73 (±3) | 13 (±2) | 5 (±1) | ±9 |
| Fibers after acid | 84 (±6) | 10 (±5) | 3 (±1) | ±3 |
| hydrolysis | | | | |
| Fibers after acid | 95 (±1) | 1 (±1) | 3 (±1) | ±1 |
| and alkali | | | | |
| treatment | | | | |

TABLE II
Chemical analysis of hemp bast fibers after selective chemical treatments

| | % α | % | % Total | % Other |
|---|---|---|---|---|
| | Cellulose | Hemicellulose | Lignin | compounds |
| Untreated fibers | 76 (±1) | 10 (±2) | 7 (±1) | ±7 |
| Fibers after acid | 86 (±3) | 6 (±1) | 5 (±1) | ±3 |
| hydrolysis | | | | |
| Fibers after acid and | 94 (±1) | 2 (±0) | 4 (±1) | — |
| alkali treatment | | | | |

### Example 5

Impact of High Pressure Homogenization

Chemically treated pulp was passed though high pressure homogenizer. By passing the suspension through the valve several times, a stable suspension of separated nanofibers was obtained. This separation was a direct consequence of the homogenization treatment in Panda homogenizer. FIG. 8 shows that the maximum percentage of the resultant nanofibers have the diameter in the range of 10-60 nm.

The homogenized samples were suspensions of separate nanofibers and had the gel-like appearance.

The cellulose obtained had at least 94% cellulose content.

The estimated crystallinity, by X-ray was 50-60%.

The yield achieved was between 20 and 25%.

Aspect ratio of resultant nanofibers, when determined using atomic force micrographs, it was observed that the same was in the range of 60-120.

TABLE III
Aspect ratio of nanofibers from different sources

| Description | Aspect ratio |
|---|---|
| Hemp nanofibers | 88 |
| Flax bast nanofibers | 77 |
| Rutabaga nanofibers | 127 |
| Wheat nanofibers | 96 |

Effect of Homogenization Time

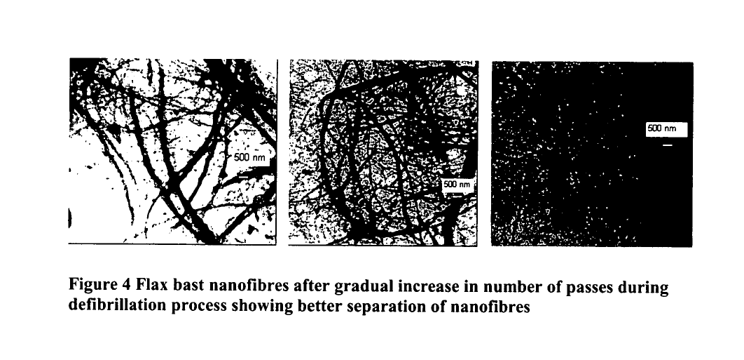

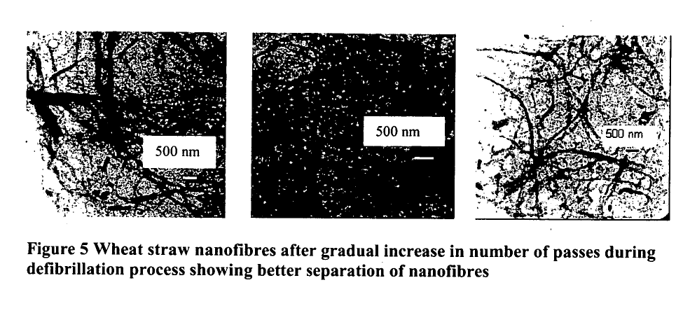

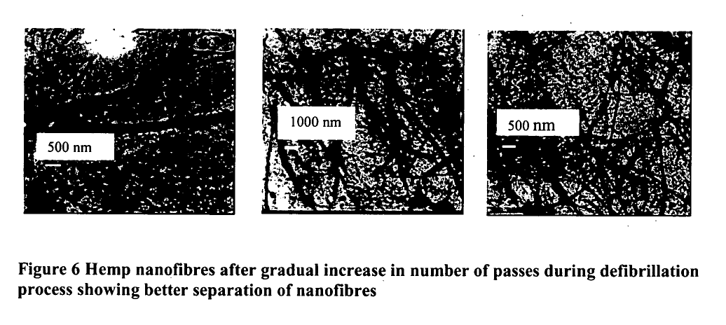

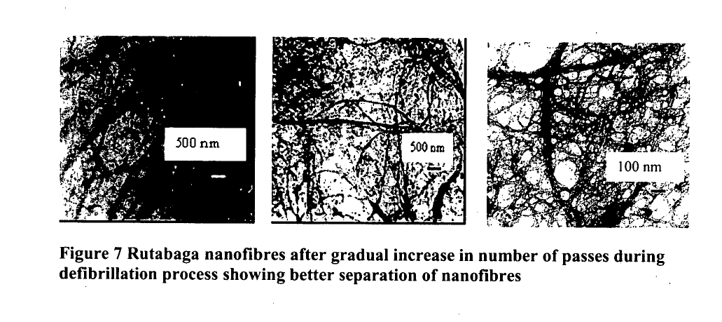

Pulp was purified using selective chemical treatments and then cryocrushed using liquid nitrogen, to liberate the nanofibers from the cell wall. Pulp was then fed to homogenizer for 5, 10, 15 and 20 times. Suspension from each stage was then examined under transmission electron microscope and it was clear that after optimum 20 passes, there a better extent of separation of nanofibers as compared to lesser number of passes (FIGS. 4, 5, 6 and 7).

At lower number of passes, TEM pictures showed that nanofibers are still entangled to each other and these fibrils diameter is in the range of microns. Increasing the number of passes shows the better isolation of nanofibers and better yield.

Number of passes through the high-pressure homogenizer is very important in achieving lower diameter of cellulose nanofibers. Macro fibrils, which are strands of nanofibers, are associated together and high shear is required to defibrillate them.

At lower number of passes, TEM pictures showed that nanofibers are still entangled to each other and these fibrils diameter is in the range of microns. Increasing the number of passes to 20, shows the better isolation of nanofibers and better yield.

Effect of Using Nanofibers as Reinforcement in Polymer Matrix

Composite films reinforced with long fibers of different levels of purification in polymer matrix was studied for their mechanical behaviour and compared with the unfilled polymer matrix and also with nanofibers reinforced composite film. Lignin, pectin and waxy substances on their external surface cover untreated long fibers. When these fibers are used as reinforcement without surface modification, the bonding between polymer matrix and fibers is not proper, therefore the reinforcing capability of fibers is very little and composite does not demonstrate the high mechanical properties. When only 10% nanofibers were used as filler in the same polymer matrix, tensile strength and young's modulus observed to be many times higher than the polymer without any nanofibers filler. It is evident from these results that nanofibers with promising strength properties and miniature size, lend themselves particularly as reinforcement in conjunction with polymers.

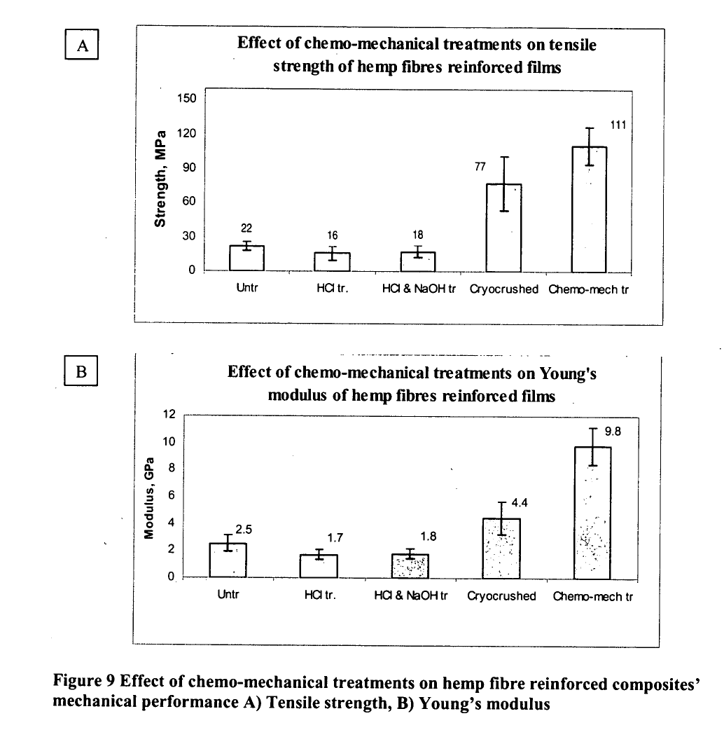

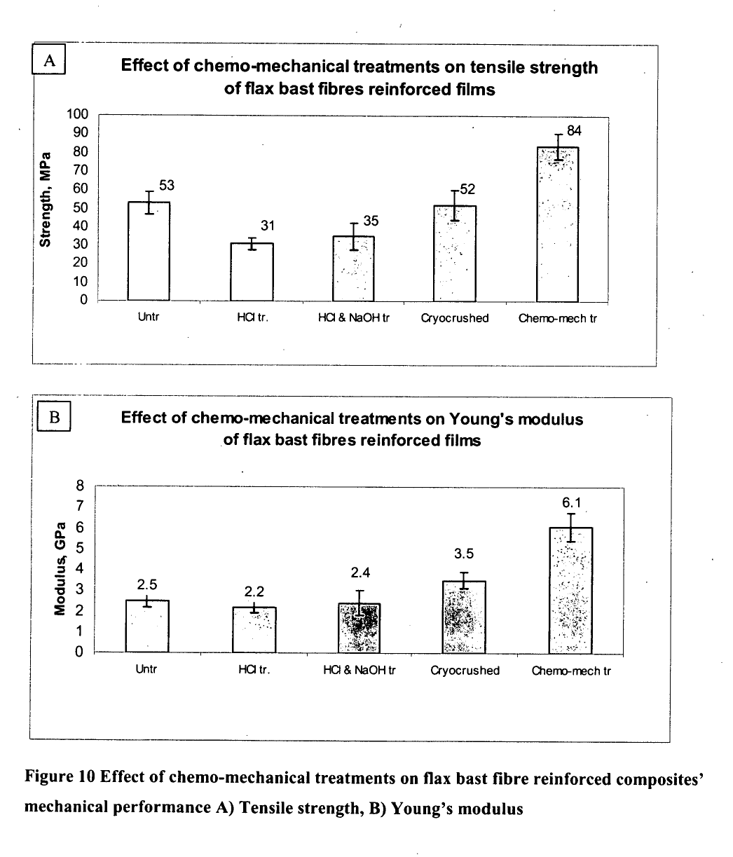

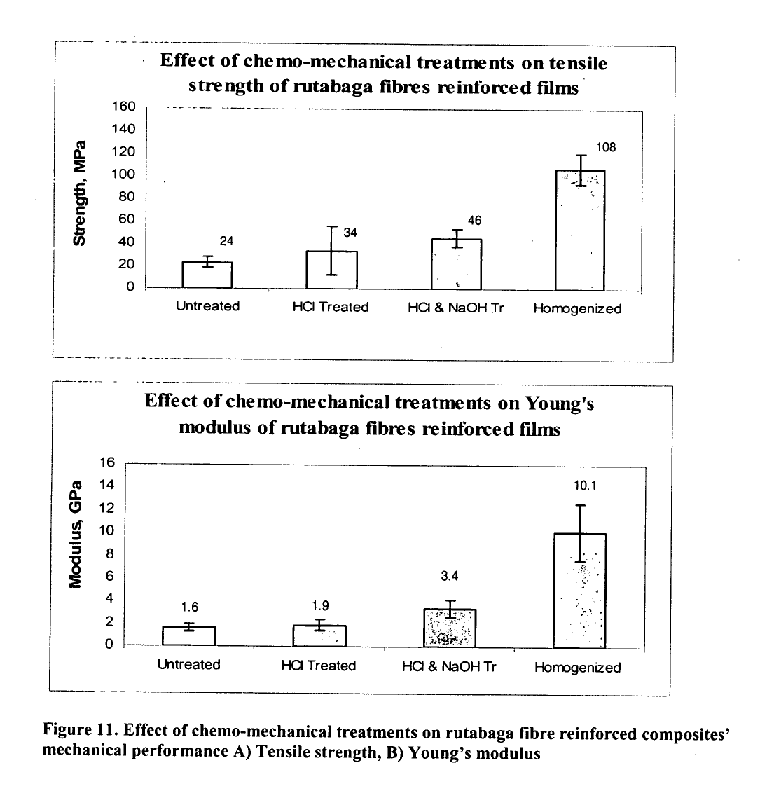

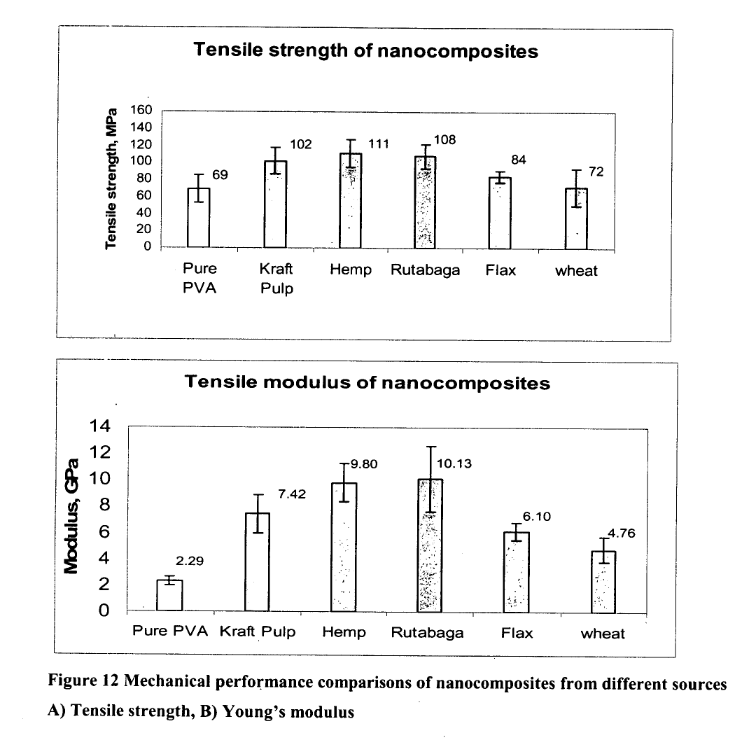

Composite films prepared with PVA and nanofibers of different raw materials like flax, hemp and rutabaga were tested for mechanical strength properties. As compared to 100% PVA film without filler, the nano-composites made with nanofibers as filler demonstrated higher strength and stiffness. Hence it can be concluded that the significant enhancement in mechanical properties can be attributed to nanofibers. (FIGS. 9, 10, 11 and 12)

While the invention has been described in terms of producing cellulose nanofibers from rutabaga, flax, hemp, wheat straws and wood Kraft pulp, other raw materials like, jute, kenaf, sisal, corn cops etc. can also be used as a source of nanofibers.

1. Cellulose nanofibers separated from the secondary cell wall by a unique chemi-mechanical process.

2. Cellulose nanofibers wherein the cellulose content is about 90 to 95%.

3. Cellulose nanofibers wherein the crystallinity of the cellulose is greater than 55%.

4. Cellulose nanofibers wherein diameter of the nanofibers are between 5 nm to 50 nm.

5. Overall yield of nanofibers is above 20%.

6. Aspect ratio of nanofibers is between 60 and 200.

7. A process for preparation of cellulose nano-fibers from secondary cell wall of pulps obtained frown natural fibers, root crops and agro based fibers containing hemicellulose, lignin, pectin and mineral materials using the following steps:
(a) hydrolyzing, the pulp with dilute acid at a temperature between about 70 degree C. to 90 degree C. to extract pectin and hemicellulose partially
(b) obtaining solid residue from suspension of step (a);
(c) a second extraction of cellulosic materials from step (b) using alkaline conditions and recovering the solid residue by separating the suspension;
(d) washing the residue from step (c);
(e) cryocrushing of the residue to obtain cell wall fragments;
(f) diluting the cellulosic material from step (e) in water or any other solvent to obtain 0.1% to 10% consistency:
(g) defibrillating the cell suspension from step (f); defibrillation step is carried out using a high pressure defibrillator using novel cell rupture technique such as passing the cell suspension through u small diameter orifice subjecting the suspension to a pressure of about 60 to 80 MPa.

8. A process according to claim 7, wherein acid hydrolysis is at a temperature between 30 degree C. and 150 degree C.

9. A process where alkaline extraction step utilizes caustic soda of concentration of 0.01% w/w to about 20% w/w.

10. A process where liquid nitrogen is used to break the cell walls into fragments with high impact application.

11. A process where after each chemical treatment the percentages of hemicelluloses, pectins & lignin decreases and percentage of cellulose increases.

12. A process according to claim 7, where cellulose resulting from step (g) is concentrated.

13. A process according to claim 7, where defibrillation step (g) is done at a temperature between 50 and 100 degree C.

14. A process where a dispersing agent such as chlorosilanes, vinyl silanes, maleated polypropylene (MAPP) etc. used to disperse the nanofibers after step (g)

15. A process for manufacturing cellulose nanofiber dispersed plastic composite by extrusion, injection molding, and casting

16. A process wherein nanofibers can be used as reinforcement for composites making for medical, packaging and industrial applications based on bio-plastics and plastics by film casting, molding and extrusion processes.

17. An aqueous composition comprising a latex polymer and a cellulose nanofibers filler, in a stable suspension and individualized in the composition
